(19) United States
(12) Patent Application Publication
(10) Pub. No.: US 2021/0368834 A1
(43) Pub. Date: Dec. 2, 2021

(54) LOW SATURATES CANOLA OIL WITH DESIRABLE POTATO FRYING PERFORMANCE OVER LIFE OF THE OIL

(71) Applicant: Cargill, Incorporated, Wayzata, MN (US)

(72) Inventors: Diliara IASSONOVA, Maple Grove, MN (US); Xiaolan LUO, Plymouth, MN (US)

(73) Assignee: Cargill, Incorporated, Wayzata, MN (US)

(21) Appl. No.: 17/255,043

(22) PCT Filed: Jun. 24, 2019
(86) PCT No.: PCT/US2019/038655

§ 371 Date: Dec. 22, 2020

Related U.S. Application Data
(60) Provisional application No. 62/688,586, filed on Jun. 22, 2018.

(51) Int. Cl. A23L 5/10; A23L 19/18; A23D 9/00

(52) U.S. Cl. CPC A23L 5/11; A23V 2002/00; A23D 9/00; A23L 19/18

(57) ABSTRACT

Described herein is a method of frying potato fries, using canola oil having an oil life of 0 to 20 days, wherein the canola comprises a total saturates content of from 3.5% to 5%, a linoleic acid content of greater than 18%, and a linolenic acid content of less than 3.0, wherein the fried potato fry has desirable aroma, texture, and flavor. Also described herein is A fried potato fry made with canola oil having an oil life of 0 to 20 days, wherein the canola oil comprises a total saturates content of from 3.5% to 5%, a linoleic acid content of greater than 18%, and a linolenic acid content of less than 3.0, wherein the fried potato fry has desirable aroma, texture, and flavor.

### TECHNICAL FIELD

This invention generally relates to canola oil containing low levels of saturated fatty acids that, when used to fry potato fries, demonstrate desirable potato fry frying characteristics after several days of oil life.

### BACKGROUND

Diets high in saturated fatty acids, or saturates, have been linked to higher levels of cholesterol and an increased risk of cardiovascular disease. Current dietary guidelines recommend that saturated fat intake should not be more than 10% of total calories. Therefore, based on a 2,000 calorie a day diet, no more than about 20 grams of saturated fat should be consumed per day. Reduction in saturated fatty acids in oils can have an impact on oil performance, however. Hence, it is desirable to have both saturated fatty acid reduction and beneficial frying performance.

### SUMMARY

Described herein is a method of frying potato fries, using canola oil having an oil life of 0 to 20 days, wherein the canola comprises a total saturates content of from 3.5% to 5%, a linoleic acid content of greater than 18%, and a linolenic acid content of less than 3.0, wherein the fried potato fry has desirable aroma, texture, and flavor. Also described herein is A fried potato fry made with canola oil having an oil life of 0 to 20 days, wherein the canola oil comprises a total saturates content of from 3.5% to 5%, a linoleic acid content of greater than 18%, and a linolenic acid content of less than 3.0, wherein the fried potato fry has desirable aroma, texture, and flavor.

### FIGURES

FIGS. 1 and 2 demonstrate a preference of low sat, high oleic canola oil over high oleic soybean oil, commodity soybean oil, and commodity canola oil amongst a number of professional sensory panelist, respectively.

FIGS. 3 and 4 demonstrate flavor is mostly picked as the reason for low saturate, high oleic canola oil preference over high oleic soybean oil.

Note that in the figures reference to “CV low sat” is the high oleic, low saturates canola oil described herein.

### DETAILED DESCRIPTION

The canola oil of the present invention has a combination of reduced saturates and desirable potato frying performance over a 20-day life of the canola oil.

“Total saturates”, as used herein, means the combination of the percentages of the following fatty acids which may be present in canola oils. Total Saturates refers to the total of myristic acid (C14:0), palmitic acid (C16:0), stearic acid (C18:0), arachidic acid (C20:0), behenic acid (C22:0), and lignoceric acid (C24:0).

“Oleic acid”, as used herein, means a C18:1 fatty acid. “Linoleic acid”, as used herein, means a C18:2 fatty acid. “Linolenic acid”, as used herein, means a C18:3 fatty acid.

“Refining or refined”, as used herein, means crude pressed or extracted canola oils that are treated by chemical or physical means to remove impurities or improve quality. Refining is well known the art and may include one or more steps to remove impurities. Any known processes to remove impurities or improve quality of vegetable oils is included within the definition of refining. See, e.g., Bailey's Industrial Oil and Fat Products, (6th Edition, 2005).

“Canola”, as used herein, means plants from the Brassica sp. including: Brassica juncea, Brassica rapa, and Brassica napus. Reference to a canola “plant” or “plants” includes the plant and its progeny, such as its F₁, F₂, F₃, F₄, and subsequent generation plants. In a specific embodiment canola is Brassica napus.

“Canola seed” or “seed”, as used herein, means the combined seeds harvested from one or more Brassica sp. plants.

Seeds harvested from plants described herein can be used to make a crude canola oil or a refined, bleached, and deodorized (RBD) canola oil with a low total saturates content. Harvested canola seed can be crushed by techniques known in the art. The seed can be tempered by spraying the seed with water to raise the moisture to, for example, about 8.5%. The tempered seed can be flaked using a smooth roller with, for example, a gap setting of 0.23 to 0.27 mm Heat may be applied to the flakes to deactivate enzymes, facilitate further cell rupturing, coalesce the oil droplets, or agglomerate protein particles to ease the extraction process. Typically, oil is removed from the heated canola flakes by a screw press to press out a major fraction of the oil from the flakes. The resulting press cake contains some residual oil. Alternatively, the tempered flakes can be extracted with hexane to yield an oil rich miscella. The miscella is subsequently desolventized to yield a crude oil. Both pressed and/or extraction processes are included in the definition of crushing.

Crude oil produced from the pressing operation typically is passed through a settling tank with a slotted wire drainage top to remove the solids expressed out with the oil in the screw pressing operation. The clarified oil can be passed through a plate and frame filter to remove the remaining fine solid particles. Canola press cake produced from the screw pressing operation can also be extracted with commercial hexane. The canola oil recovered after solvent evaporation from the extraction process is combined with the clarified oil from the screw pressing operation, resulting in a combined crude oil.

Free fatty acids and gums typically are removed from the crude oil by adding food grade phosphoric acid and heating the acidified oil in a batch refining tank. The acid serves to convert the non-hydratable phosphatides to a hydratable form, and to chelate minor metals that are present in the crude oil. The oil-acid mixture is subsequently treated with sodium hydroxide solution to neutralize the free fatty acids and the remaining phosphoric acid in the acid-oil mixture. The neutralized free fatty acids, metal salts, phosphatides, etc. (soapstock) are drained off from the neutralized oil. A water wash may be done to further reduce the soap content of the oil. The oil may be bleached and deodorized before use, if desired, by standard techniques known in the art. See, e.g., Bailey's Industrial Oil and Fat Products, (6th Edition, 2005).

Oils obtained from the Brassica plant described herein can have increased oxidative stability, which can be measured using, for example, an Oxidative Stability Index Instrument (e.g., from Omnion, Inc., Rockland, Mass.) according to AOCS Official Method Cd 12b-92 (revised 1993). Oxidative stability is often expressed in terms of “AOM” hours.

Linolenic Acid—As mentioned above, to maintain stability C18:3 levels should be kept as low as possible appreciating that it is increasingly difficult to produce plants with ultra-low levels of linolenic acid. Embodiments of the present invention have linolenic acid level in canola seed of between 1.5% and 3%. Additional embodiments have levels from i) 1.5% to 2.5%; ii) 1.65% to 2.5%; or iii) 1.1% to 3.1%.

Linoleic—A specific level of C18:2 linoleic acid is desired in the canola seed an oil of the present invention. Embodiments of the present invention have linolenic acid level in the canola seed or oil of greater than 18% or 20%. Additional embodiments have levels from i) 21% to 28%; ii) 24% to 26%; iii) 21.1% to 28.8%; or iv) 18% to 30.6%.

Oleic—Embodiments of the present invention have oleic acid level in the canola seed or oil of greater than 60% or 65%. Additional embodiments have levels from i) 60% to 70%; ii) 63% to 68%; or iii) 59.9% to 73.6%.

Total Saturates—Embodiments of the present invention have a total saturates level of less than 5%. Commodity canola oils commonly used in industry and by consumers have saturate levels of between 6-8%. See, e.g., Bailey's Industrial Oil and Fat Products, Section 2.2, “Canola Oil” on pages 61-121 of Volume 2 (6th Edition, 2005). Embodiments of the present invention have total saturates level in the canola seed or oil of between 3.5% and 5%. Additional embodiments have levels from i) 4% to 5%; ii) 4 to 4.5%; iii) 4.2% to 4.7%; and iv) 3.8% to 5.9%.

All possible combinations of the values for linoleic, linolenic, and total saturates mentioned above are within the scope of the present invention and are specifically contemplated by the inventor. For example, combinations include but are not envisioned to be limited to the following.

TABLE I

| Embodiment | % Linoleic | % Linolenic | % Total Saturates |
|---|---|---|---|
| A | >18 | 1.5-3 | 3.5-5 |
| B | >20 | 1.5-3 | 3.5-5 |
| C | >20 | 1.5-2.75 | 4-5 |
| E | 20-25 | 1.5-2.75 | 3.5-5 |
| F | 21-28 | 1.5-2.75 | 4-5 |
| G | 21-28 | 1.5-2.75 | 4.2-4.7 |
| H | 18-30.6 | 1.1-2.9 | 4.1-5.3 |

Embodiments in Table I can further comprise specific oleic acid content. Examples of embodiments with specific oleic content include but are not limited to the following: (>60%, >65%, 65% to 70%, 64% to 68%; and 59.9% to 73.6%.)

Three examples of such plants were deposited with the American Type Culture Collection.

| Example | Internal Designation | ATCC Designation |
|---|---|---|
| 1 | 15RH0611 | PTA-12314 |
| 2 | 15RH0612 | PTA-12315 |
| 3 | 15RH0613 | PTA-12316 |

Over time, oils tend to degrade over a period of time due to oxidation and other effects which impacts their frying performance over time. Surprisingly the low saturates oil described herein demonstrate beneficial frying characteristics over a 20-day life of the oil on potato fry products. The frying performance specifically on potato fries is better relative to other oils in the industry.

Frying performance of potato fries is determined based on the characteristics of the fried potato fry, specifically aroma, texture, and flavor. Sensory analysis shows that over a 20-day life of the low saturates oil described herein, potato fries fried using this oil have desirable and improved aroma, texture, and flavor relative to other industry oils. Initial potato fries (prior to frying with the low saturates oil described herein) can include par-fried potato fries and non-fried potato fries, with or without coating.

Embodiments of the present invention also include methods of frying potato fries, comprising heating the low saturates oil to a temperature ranging from 330-340 F and immersing the potato fries in the heated oil for a frying time of about 3 minutes to 3 minutes and 30 seconds. This method produces a fried potato fry with desirable aroma, texture, and flavor over a 20-day life of the oil.

It shall be understood that while the many aspects described herein involve frying potato fries, such oil and methods can also be applied to meat and seafood protein sources, for example chicken.

### EXAMPLES

### Example #1

The objective is to evaluate frying performance of the low saturates, high oleic canola oil described herein and understand its performance relative to other oils in the industry after 20-days of oil life. The characteristics of oils tested (fresh oil) are described in Table 1.

TABLE 1

| | | | | | Low Saturates, |
|---|---|---|---|---|---|
| | | | | | High Oleic |
| Sample | Soy | High Oleic | High Oleic | High Oleic | Canola Oil as |
| Description | (Commodity) | Soybean Oil | Canola Oil 1 | Canola Oil 2 | described herein |
| Free Fatty Acids | 0.02 | 0.03 | 0.06 | 0.02 | 0.04 |
| as oleic (%) | | | | | |
| Peroxide Value | 0.00 | 0.04 | 0.00 | 0.16 | 0.08 |
| [meq/kg] | | | | | |
| p-Anisidine | 1.60 | 0.60 | 1.51 | 1.60 | 1.83 |
| C 18:1 total | 21.66 | 74.36 | 66.03 | 72.26 | 69.33 |
| [oleic acid] | | | | | |
| C 18:2 total | 54.18 | 9.52 | 23.11 | 17.06 | 21.84 |
| [linoleic acid] | | | | | |
| C 18:3 total | 8.14 | 2.51 | 2.38 | 2.09 | 2.75 |
| [linolenic acid] | | | | | |
| SAFA | 15.60 | 11.75 | 7.00 | 7.03 | 4.25 |
| Trans FA | 1.34 | 0.19 | 0.57 | 0.50 | 1.08 |
| TPM(100-TAG) | 1.84 | 2.07 | 2.61 | 2.91 | 2.93 |

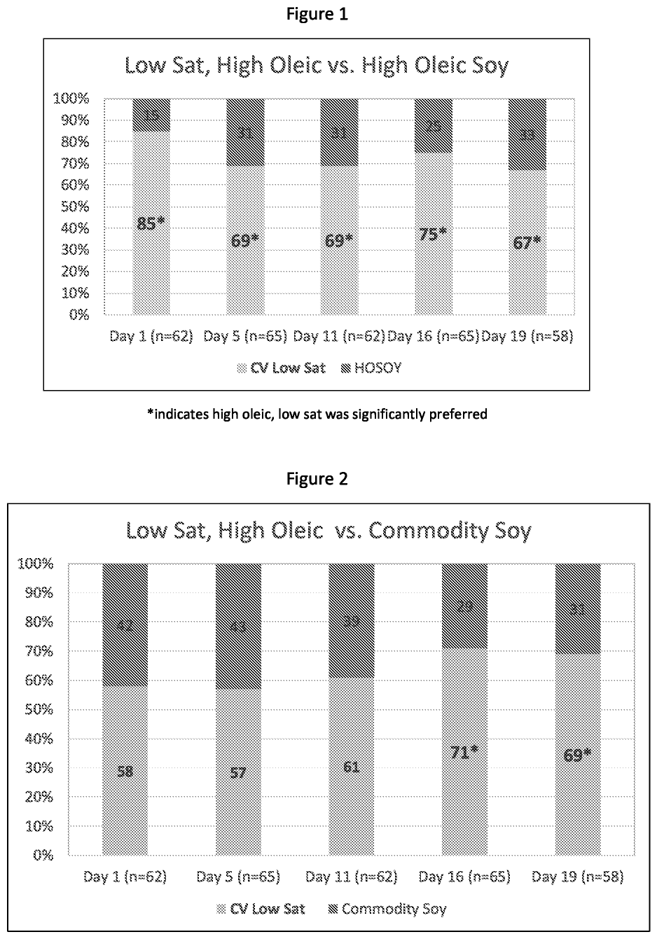

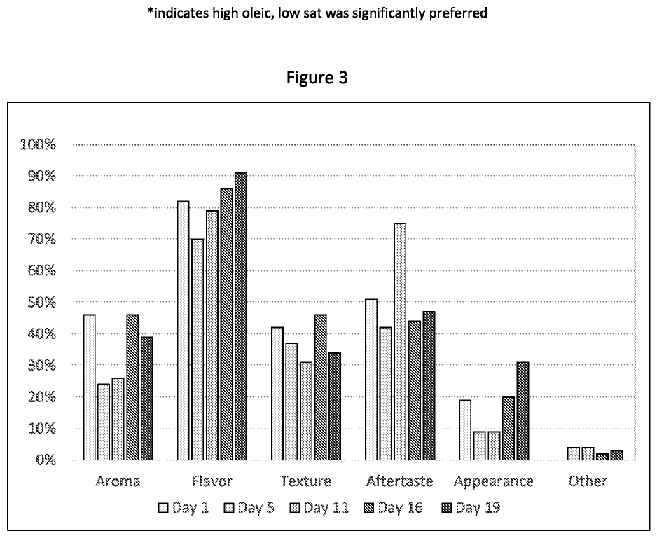

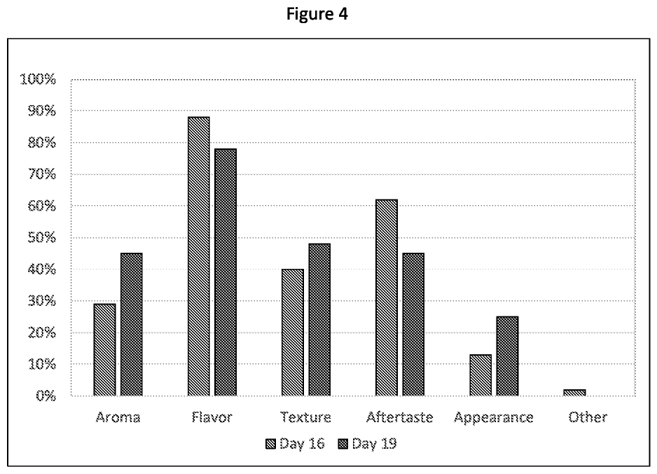

A twenty-day oil life study was carried out on par-fried potato fries. Samples of the oil were taken for a 20-day period and analytical testing on par-fried potato fries was carried out on each day. The fry conditions were 330-340° F. for 3 minutes to 3 minutes and 30 seconds. The characteristics of par-fried potato fries fried using 14-day old oil show desirable aroma, flavor, and texture in Table 2. The characteristics of par-fried potato fries fried using 20-day old oil show desirable aroma, flavor, and texture in Table 3. Further, FIGS. 1 and 2 demonstrate a preference of low saturate, high oleic canola oil over high oleic soybean oil, commodity soybean oil, and commodity canola oil amongst a number of professional sensory panelist when comparing aroma, flavor and texture holistically. And as demonstrated in FIGS. 3 and 4, flavor was mostly picked as the reasons for low saturate, high oleic canola oil preference over high oleic soybean oil.

TABLE 2
Sensory Preference Testing (n = 15)
Tables show the mean of ranks for each attribute. For samples showing a
significant difference, the sample with the lower mean is more preferred.

| | Low Sat, High | |
|---|---|---|
| | Oleic Canola | |
| | (described herein) | High Oleic Soybean Oil |
| Aroma | 1.0 | 2.0 |
| Flavor | 1.4 | 1.6 |
| Texture | 1.4 | 1.6 |
| Overall Preference | 1.4 | 1.6 |
| | Low Sat, High | |
| | Oleic Canola | |
| | (described herein) | High Oleic Canola Oil 2 |
| Aroma | 1.5 | 1.5 |
| Flavor | 1.5 | 1.5 |
| Texture | 1.4 | 1.6 |
| Overall Preference | 1.5 | 1.5 |
| | Low Sat, High | |
| | Oleic Canola | |
| | (described herein) | High Oleic Canola Oil 1 |
| Aroma | 1.4 | 1.6 |
| Flavor | 1.3 | 1.7 |
| Texture | 1.1 | 1.9 |
| Overall Preference | 1.2 | 1.8 |
| | Low Sat, High | |
| | Oleic Canola | |
| | (described herein) | Commodity Soy |
| Aroma | 1.3 | 1.7 |
| Flavor | 1.4 | 1.4 |
| Texture | 1.5 | 1.5 |
| Overall Preference | 1.4 | 1.6 |

TABLE 3
Sensory Preference Testing (n = 11)
Tables show the mean of ranks for each attribute. For samples showing a
significant difference, the sample with the lower mean is more preferred.

| | Low Sat, High | |
|---|---|---|
| | Oleic Canola | |
| | (described herein) | High Oleic Soybean Oil |
| Aroma | 1.4 | 1.6 |
| Flavor | 1.3 | 1.7 |
| Texture | 1.3 | 1.7 |
| Overall Preference | 1.3 | 1.7 |
| | Low Sat, High | |
| | Oleic Canola | |
| | (described herein) | High Oleic Canola Oil 2 |
| Aroma | 1.3 | 1.7 |
| Flavor | 1.5 | 1.5 |
| Texture | 1.2 | 1.8 |
| Overall Preference | 1.4 | 1.6 |
| | Low Sat, High | |
| | Oleic Canola | |
| | (described herein) | Commodity Soy |
| Aroma | 1.4 | 1.6 |
| Flavor | 1.3 | 1.7 |
| Texture | 1.3 | 1.7 |
| Overall Preference | 1.3 | 1.7 |

1. A method of frying potato fries, using canola oil having an oil life of 0 to 20 days, wherein the canola comprises a total saturates content of from 3.5% to 5%, a linoleic acid content of greater than 18%, and a linolenic acid content of less than 3.0.

2. The method of claim 1, wherein the potato fry is fried in 14-day old canola oil.

3. The method of claim 1, wherein the potato fry is fried in 20-day old canola oil.

4. The method of claim 1, wherein the potato fry is a par-fried potato fry.

5. The method of claim 1, comprising frying the potato fry at a temperature ranging from 330-340 F.

6. The method of claim 5, comprising frying the potato fry for about 3 minutes to 3 minutes and 30 seconds.

7. A fried potato fry made with canola oil having an oil life of 0 to 20 days, wherein the canola oil comprises a total saturates content of from 3.5% to 5%, a linoleic acid content of greater than 18%, and a linolenic acid content of less than 3.0, wherein the fried potato fry has desirable aroma, texture, and flavor than other high oleic and commodity oils.

8. The fried potato fry of claim 7, wherein the potato fry is fried in 14-day old canola oil.

9. The fried potato fry of claim 7, wherein the potato fry is fried in 20-day old canola oil.

10. The method of claim 1, wherein the fried potato fry has a more desirable aroma, texture, and flavor than other high oleic and commodity oils.

11. The method of claim 10, wherein the aroma has a sensory range of 1.0-1.5.

12. The method of claim 10, wherein the texture has a sensory range of 1.1-1.5.

13. The method of claim 10, wherein the flavor has a sensory range of 1.3-1.5.
